(19) United States
(12) Patent Application Publication
(10) Pub. No.: US 2016/0275294 A1
(43) Pub. Date: Sep. 22, 2016

(54) DATA SYSTEM AND METHOD

(71) Applicant: The MaidSafe Foundation, Troon (GB)

(72) Inventor: David Irvine, Troon (GB)

(21) Appl. No.: 14/659,390

(22) Filed: Mar. 16, 2015

(51) Int. Cl. G06F 21/60; G06Q 20/40; G06F 21/56

(52) U.S. Cl. CPC G06F 21/602; G06F 21/56; G06Q 20/401; G06Q 2220/00; G06F 2221/034

(57) ABSTRACT

A data system for providing data communication includes at least one user device and a configuration of nodal elements which is operable to communicate with the at least one user device. The data system is operable to communicate data therein in a format which includes data chunks which have been encrypted and obfuscated and are defined by one or more data maps. Moreover, the data system is susceptible to being configured for providing secure data communication and storage, simultaneously with providing a high degree of user privacy. The data system has potential widespread use in a wide spectrum of applications.

### TECHNICAL FIELD

The present disclosure relates to data systems, for example to data systems for providing secure and robust data storage and data communication. Moreover, the present disclosure concerns methods of storing and communicating data. Furthermore, the present disclosure relates to computer program products comprising a non-transitory (non-transient) computer-readable storage medium having computer-readable instructions stored thereon, the computer-readable instructions being executable by a computerized device comprising processing hardware to execute aforementioned methods.

### BACKGROUND

It is common practice for users to backup local data from their user devices onto data storage media of one or more remote computing nodes, such that user data is not lost in an event that the user devices are lost, stolen or malfunction. One form of centrally storing user local data includes contemporary “cloud computing” arrangements. Increasingly, data services are provided from the computing nodes, namely via aforementioned “cloud computing”. Data services available include, for example, on-line purchasing and retailing, wherein details of user retail searching choices, purchase history and various other information are stored at the computing nodes.

Recently, “data mining”, personal privacy and protection of data have become major political issues, and users are increasingly demanding that stricter controls regarding dissemination of their data be provided by operators. Moreover, a large commercial service industry has also arisen around mining and selling analyses of user data via, for example, contemporary social media websites, cloud-based e-mail services, etc. However, such data mining is potentially susceptible to misuse. For example, mined data may be used for purposes of blackmail or theft.

### SUMMARY

The present disclosure seeks to provide a data system which is operable to provide an increased degree of data security and data privacy.

Moreover, the present disclosure seeks to provide a method of operating a data system for providing an increased degree of data security and data privacy.

Furthermore, the present disclosure seeks to arrangements and configurations for using the aforementioned data system which benefit from its increased degree of data security and data privacy.

Furthermore, the present disclosure seeks to provide a system for cryptocurrencies.

According to a first aspect, there is provided data system for providing data communication and data storage, wherein the data system includes at least one user device and a configuration of nodal elements which is operable to communicate with the at least one user device, characterized in that

the data system is operable to communicate data therein in a format which includes data chunks which have been encrypted and obfuscated and are defined by one or more data maps; and

the at least one user device includes at least one intermediate device which is spatially locally coupled to at least one user-wearable device.

The invention is of advantage in that use of the data chunks that have been encrypted and obfuscated enables more secure communication and storage of information, for example reduces a risk of third party eavesdropping and corruption of user data, for example wherein the user data is communicated from the at least one user-wearable device.

Optionally, the data system is implemented such that the one user-wearable device is operable to enable cryptocurrency payments to be made by an associated user of the at least one user device.

Optionally, the data system is implemented such that the at least one user-wearable device includes at least one sensor for sensing in a spatial region of the at least one user-wearable device, and for communicating corresponding sensor data from the at least one user-wearable device via the at least one intermediate device for storage at one or more nodal elements of the data system.

More optionally, the data system is implemented such that the data system is operable to employ a primary format, which includes data chunks which have been encrypted and obfuscated and are defined by one or more data maps, for communicating data from the at least one user-wearable device to the at least one intermediate device, and to employ a secondary format, which includes data chunks which have been encrypted and obfuscated and are defined by one or more data maps, for communicating further the data in the primary format from the at least one intermediate device to one or more nodal elements of the data system.

According to second aspect, there is provided a data system for providing data communication, wherein the data system includes at least one user device and a configuration of nodal elements which is operable to communicate with the at least one user device, characterized in that

the data system is operable to communicate data therein in a format which includes data chunks which have been encrypted and obfuscated and are defined by one or more data maps; and

the at least one user device includes at least one power-consuming electrical apparatus coupled to an electrical supply network; and

the system further includes a control arrangement for providing load balancing within the electrical supply network, wherein the control arrangement is operable to send load adjustment data in the format to the at least one user device to vary power consumption of the at least one power-consuming electrical apparatus to provide load balancing within the electrical supply network.

Optionally, the data system is implemented such that the at least one power-consuming electrical apparatus includes at least one of:

(i) refrigeration and/or air conditioning equipment;

(ii) an electric water immersion heater;

(iii) electrical room heating;

(iv) electrical lighting;

(v) ventilation equipment; and

(vi) electric vehicle charging apparatus.

Optionally, the data system is implemented such that the data system is operable to receive power consumption data communicated from electrical power consumption meters associated with the one or more user devices, wherein the power consumption data is communicated in the format.

According to a third aspect, there is provided a data system for providing data communication, wherein the data system includes at least one user device and a configuration of nodal elements which is operable to communicate with the at least one user device, characterized in that

the data system is operable to communicate data therein in a format which includes data chunks which have been encrypted and obfuscated and are defined by one or more data maps; and

the system is operable to provide at least one of: transaction, authentication and payment associated with legal instruments, wherein the legal instruments include at least one of:

(i) fiat currency payments;

(ii) cryptocurrency payments;

(iii) commercial procurement contracts; and

(iv) licensing contracts;

(v) commercial derivatives product transactions on stock exchanges.

According to a fourth aspect, there is provided a data system for providing data communication and data storage, wherein the data system includes at least one user device and a configuration of nodal elements which is operable to communicate with the at least one user device, characterized in that

the data system is operable to communicate data therein in a format which includes data chunks which have been encrypted and obfuscated and are defined by one or more data maps; and

the at least one user device includes a data filter for generating metadata from user data communicated in the format from the at least one user device to the configuration of nodal elements, wherein the metadata is useable to the data system for purposes of searches.

Optionally, the data system is implemented, such that the data filter has one or more filter parameters which are user-definable for controlling generation of the metadata.

According to a fifth aspect, there is provided a data system for providing data communication and data storage, wherein the data system includes at least one user device and a configuration of nodal elements which is operable to communicate with the at least one user device, characterized in that

the data system is operable to communicate data therein in a format which includes data chunks which have been encrypted and obfuscated and are defined by one or more data maps; and

the at least one user device includes a protection arrangement for detecting activities of spyware and/or ransomware which are concurrently executing on the at least one user device.

Optionally, the data system is implemented, such that the at least one user device is operable to monitor data flows occurring therefrom in operation and to correlate the monitored data flows with expected data flows from the device, and to detect the spyware and/or ransomware by detecting a discrepancy in the correlation.

More optionally, the data system is implemented, such that the discrepancy is detected by size of data flow and/or temporal characteristics of the data flow.

According to a sixth aspect, there is provided a data system for providing data communication, wherein the data system includes at least one user device and a configuration of nodal elements which is operable to communicate with the at least one user device, characterized in that

the data system is operable to communicate data therein in a format which includes data chunks which have been encrypted and obfuscated and are defined by one or more data maps; and

the data system is configured to provide for at least one of:

(i) video conferencing; and

(ii) audio conferencing.

According to a seventh aspect, there is provided a data system for providing data communication and data storage, wherein the data system includes at least one user device and a configuration of nodal elements which is operable to communicate with user devices, characterized in that

the data system is operable to communicate data therein in a format which includes data chunks which have been encrypted and obfuscated and are defined by one or more data maps; and

the user devices include gaming console arrangements, wherein the data system is operable to enable gaming interactions between the user devices.

Optionally, the data system is implemented, such that the data system is operable to record gaming interactions at the nodal elements for subsequent replay to users of the user devices.

According to an eighth aspect, there is provided a data system for providing data communication and data storage, wherein the data system includes at least one user device and a configuration of nodal elements which is operable to communicate with the at least one user device, characterized in that

the data system is operable to communicate data therein in a format which includes data chunks which have been encrypted and obfuscated and are defined by one or more data maps; and

the at least one user device is implemented to provide at least one of:

(i) a road traffic control arrangement;

(ii) a railway traffic control arrangement;

(iii) an aviation traffic control arrangement;

(iv) a maritime traffic control arrangement.

According to a ninth aspect, there is provided a method of communicating data within a data system for providing data communication and data storage, wherein the data system includes at least one user device and a configuration of nodal elements which is operable to communicate with the at least one user device, characterized in that the method includes:
(i) operating the data system to communicate data therein in a format which includes data chunks which have been encrypted and obfuscated and are defined by one or more data maps; and
(ii) arranging for the at least one user device to includes at least one intermediate device which is spatially locally coupled to at least one user-wearable device.

Optionally, the method is implemented, such that the at least one user-wearable device is operable to enable cryptocurrency payments to be made by an associated user of the at least one user device.

More optionally, the method includes arranging for the at least one user-wearable device to include at least one sensor for sensing in a spatial region of the at least one user-wearable device, and for communicating corresponding sensor data from the at least one user-wearable device via the at least one intermediate device for storage at one or more nodal elements of the data system.

More optionally, the method includes arranging for the data system to employ a primary format, which includes data chunks which have been encrypted and obfuscated and are defined by one or more data maps, for communicating data from the at least one user-wearable device to the at least one intermediate device, and to employ a secondary format, which includes data chunks which have been encrypted and obfuscated and are defined by one or more data maps, for communicating further the data in the primary format from the at least one intermediate device to one or more nodal elements of the data system.

According to a tenth aspect, there is provided a method of communicating data in a data system for providing data communication and data storage, wherein the data system includes at least one user device and a configuration of nodal elements which is operable to communicate with the at least one user device, characterized in that the method includes:
(i) using the data system to communicate data therein in a format which includes data chunks which have been encrypted and obfuscated and are defined by one or more data maps; and
(ii) arranging for the at least one user device to include at least one power-consuming electrical apparatus coupled to an electrical supply network; and
(iil) arranging for the data system to include a control arrangement for providing load balancing within the electrical supply network, wherein the control arrangement is operable to send load adjustment data in the format to the at least one user device to vary power consumption of the at least one power-consuming electrical apparatus to provide load balancing within the electrical supply network.

Optionally, the method is implemented, such that the at least one power-consuming electrical apparatus includes at least one of:

(i) refrigeration and/or air conditioning equipment;

(ii) an electric water immersion heater;

(iii) electrical room heating;

(iv) electrical lighting;

(v) ventilation equipment; and

(vi) electric vehicle charging apparatus.

Optionally, the method is implemented, such that the data system is operable to receive power consumption data communicated from electrical power consumption meters associated with the one or more user devices, wherein the power consumption data is communicated in the format.

According to an eleventh aspect, there is provided a method of communicating data within a data system for providing data communication and data storage, wherein the data system includes at least one user device and a configuration of nodal elements which is operable to communicate with the at least one user device, characterized by a method that includes:
(i) using the data system to communicate data therein in a format which includes data chunks which have been encrypted and obfuscated and are defined by one or more data maps; and
(ii) using the data system to provide at least one of: transaction, authentication and payment associated with legal instruments, wherein the legal instruments include at least one of:
   (a) fiat currency payments;
   (b) cryptocurrency payments;
   (c) commercial procurement contracts; and
   (d) licensing contracts;
   (e) commercial derivatives product transactions on stock exchanges.

According to a twelfth aspect, there is provided a method of using a data system for providing data communication and data storage, wherein the data system includes at least one user device and a configuration of nodal elements which is operable to communicate with the at least one user device, characterized in that the method includes:
(i) using the data system to communicate data therein in a format which includes data chunks which have been encrypted and obfuscated and are defined by one or more data maps; and
(ii) arranging for the at least one user device to include a data filter for generating metadata from user data communicated in the format from the at least one user device (30) to the configuration of nodal elements, wherein the metadata is useable to the data system for purposes of searches.

Optionally, in the method, the data filter has one or more filter parameters which are user-definable for controlling generation of the metadata.

According to thirteenth aspect, there is provided a method of using a data system for providing data communication and data storage, wherein the data system includes at least one user device and a configuration of nodal elements which is operable to communicate with the at least one user device, characterized in that the method includes:
(i) using the data system to communicate data therein in a format which includes data chunks which have been encrypted and obfuscated and are defined by one or more data maps; and
(ii) arranging for the at least one user device to include a protection arrangement for detecting activities of spyware and/or ransomware which are concurrently executing on the at least one user device.

Optionally, the method is implemented, such that the at least one user device is operable to monitor data flows occurring therefrom in operation and to correlate the monitored data flows with expected data flows from the device, and to detect the spyware and/or ransomware by detecting a discrepancy in the correlation.

Optionally, the method is implemented, such that the discrepancy is detected by size of data flow and/or temporal characteristics of the data flow.

According to a fourteenth aspect, there is provided a method of using a data system for providing data communication, wherein the data system includes at least one user device and a configuration of nodal elements which is operable to communicate with the at least one user device, characterized in that the method includes:
(i) using the data system to communicate data therein in a format which includes data chunks which have been encrypted and obfuscated and are defined by one or more data maps; and
(ii) configuring the data system to provide for at least one of:
   (a) video conferencing; and
   (b) audio conferencing;

According to a fifteenth aspect, there is provided a method of using a data system for providing data communication and data storage, wherein the data system includes at least one user device and a configuration of nodal elements which is operable to communicate with user devices, characterized in that the method includes:
(i) using the data system to communicate data therein in a format which includes data chunks which have been encrypted and obfuscated and are defined by one or more data maps; and
(ii) arranging the user devices to include gaming console arrangements, wherein the data system is operable to enable gaming interactions between the user devices.

Optionally, the method is implemented, such that the data system is operable to record gaming interactions at the nodal elements for subsequent replay to users of the user devices.

According to a sixteenth aspect, there is provided a method of using a data system for providing data communication and data storage, wherein the data system includes at least one user device and a configuration of nodal elements which is operable to communicate with the at least one user device, characterized in that the method includes:
(i) using the data system to communicate data therein in a format which includes data chunks which have been encrypted and obfuscated and are defined by one or more data maps; and
(ii) implementing the at least one user device to provide at least one of:
   (a) a road traffic control arrangement;
   (b) a railway traffic control arrangement;
   (c) an aviation traffic control arrangement;
   (d) a maritime traffic control arrangement.

According to a seventeenth aspect, there is provided a computer program product comprising a non-transitory computer-readable storage medium having computer-readable instructions stored thereon, the computer-readable instructions being executable by a computerized device comprising processing hardware to execute a method according to any one of the ninth to sixteenth aspects.

According to a eighteenth aspect, there is provided a non-transitory computer-readable medium for communicating data within a data system, wherein the data system includes at least one user device and a configuration of nodal elements operable to communicate with the at least one user device, and wherein the computer-readable medium includes instructions stored thereon, that when executed on a processor cause one or more computers to perform the steps of communicating data within the data system in a secure format which includes data chunks which have been encrypted and obfuscated and are defined by one or more data maps.

Optionally, communicating data within the system in the secure format in accordance with the stored instructions further includes communicating the data within the system in the secure format between the configuration of nodal elements and the at least one user device which includes at least one intermediate device spatially locally coupled to at least one user-wearable device.

Optionally, the instructions stored on the non-transitory computer-readable medium, when executed on a processor cause the one user-wearable devices to perform the step of transacting cryptocurrency payments on behalf of a user associated with the one user-wearable device.

Optionally, the instructions stored on the non-transitory computer-readable medium, when executed on a processor, cause one or more computers to perform the steps of communicating, via the at least one intermediate device, sensor data corresponding to a sensor included with the one user-wearable device and configured to sense in a spatial region of the one user-wearable device; and storing the sensor data at one or more nodal elements of the data system.

Optionally, the instructions stored on the non-transitory computer-readable medium, when executed on a processor, cause one or more computers to perform the steps of constructing a primary format, which includes data chunks which have been encrypted and obfuscated and are defined by one or more data maps; communicating data in the primary format from the at least one user-wearable device to the at least one intermediate device; constructing a secondary format, which includes data chunks which have been encrypted and obfuscated and are defined by one or more data maps; and communicating further the data in the primary format from the at least one intermediate device to one or more nodal elements of the data system.

Optionally, the instructions stored on the non-transitory computer-readable medium, when executed on a processor, cause one or more computers to perform the step of sending load adjustment data in the secure format to the at least one user device to vary power consumption of at least one power-consuming electrical apparatus to provide load balancing within an electrical supply network to which the power-consuming electrical apparatus is coupled.

Optionally, the instructions stored on the non-transitory computer-readable medium, when executed on a processor, cause one or more computers to perform the steps of sending load adjustment data in the secure format to cause one or more computers to vary power consumption of at least one of refrigeration and/or air conditioning equipment; an electric water immersion heater; electrical room heating; electrical lighting; ventilation equipment; and electric vehicle charging apparatus.

Optionally, the instructions stored on the non-transitory computer-readable medium, when executed on a processor, cause one or more computers to perform the step of receiving power consumption data communicated in the secure format from electrical power consumption meters associated with the one or more user devices.

Optionally, the instructions stored on the non-transitory computer-readable medium, when executed on a processor, cause one or more computers to perform the steps of: transaction, authentication and payment associated with legal instruments. The legal instruments optionally include at least one of fiat currency payments; cryptocurrency payments; commercial procurement contracts; licensing contracts; and commercial derivatives product transactions on stock exchanges.

Optionally, the instructions stored on the non-transitory computer-readable medium, when executed on a processor, cause the at least one user device to perform the steps of with a data filter generating metadata from data communicated in the secure format from the at least one user device to the configuration of nodal elements; searching with the metadata; and mining the metadata.

Optionally, the instructions stored on the non-transitory computer-readable medium, when executed on a processor, cause the at least one user device to perform the step of controlling generation of the metadata by the data filter with one or more user-defined filter parameters.

Optionally, the instructions stored on the non-transitory computer-readable medium, when executed on a processor, cause one or more computers to perform the steps of monitoring data flows occurring from the at least one user device in operation and uncovering malware by detecting a discrepancy between size and/or temporal characteristics of the monitored data flows and expected size and/or temporal characteristics of data flows from the device.

Optionally, the step of communicating data within the data system in a format which includes data chunks which have been encrypted and obfuscated and are defined by one or more data maps in accordance with the stored instructions further comprises at least one of communicating video conferencing data, communicating audio conferencing data and controlling remote cameras of the at least one user device.

Optionally, the step of communicating data within the data system in a format which includes data chunks which have been encrypted and obfuscated and are defined by one or more data maps in accordance with the stored instructions further comprises communicating gaming interactions between gaming console arrangements.

Optionally, the instructions stored on the non-transitory computer-readable medium, when executed on a processor, cause one or more computers to perform the steps of recording gaming interactions at the nodal elements and replaying the gaming interactions at the user devices.

Optionally, the instructions stored on the non-transitory computer-readable medium, when executed on a processor, cause one or more computers to perform at least one of the steps of controlling road traffic, controlling railway traffic, controlling aviation traffic and controlling maritime traffic.

It will be appreciated that features of the invention are susceptible to being combined in various combinations without departing from the scope of the invention as defined by the appended claims.

### DESCRIPTION OF THE DIAGRAMS

Embodiments of the present disclosure will now be described, by way of example only, with reference to the following diagrams wherein:

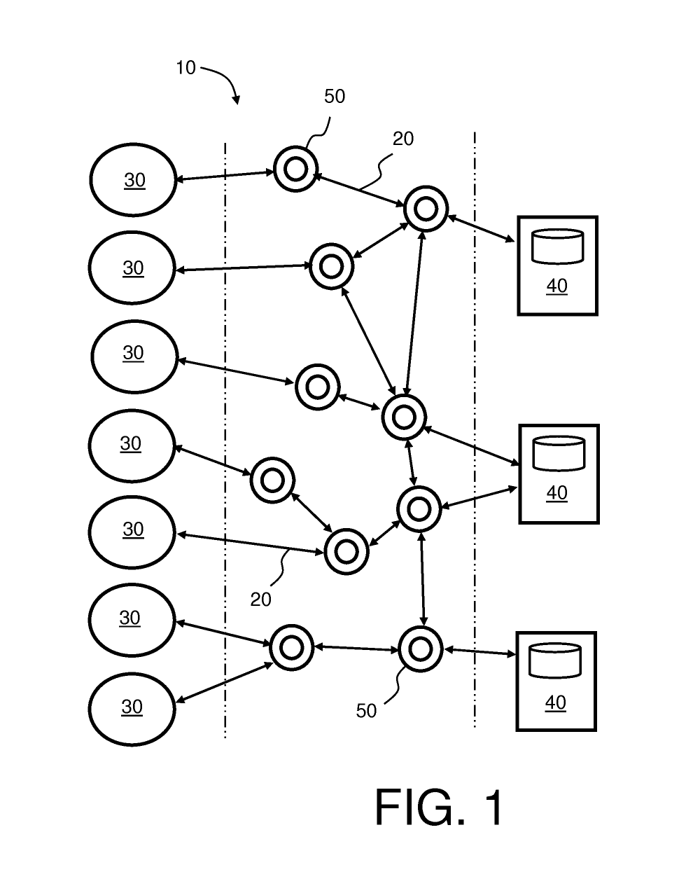

FIG. 1 is an illustration of a data system of the present disclosure including a plurality of elements coupled via data communication links;

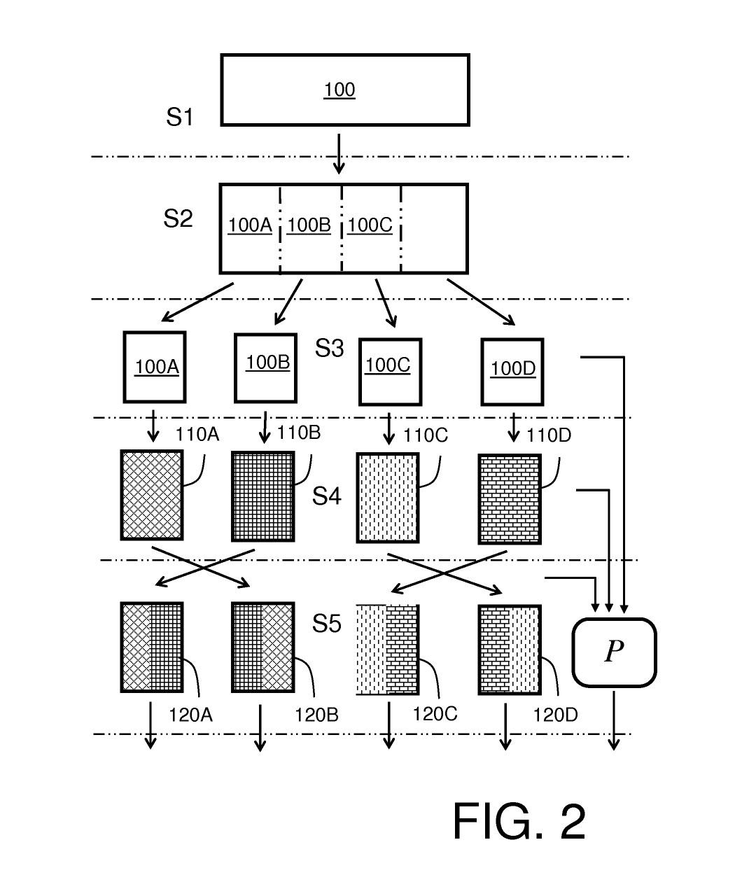

FIG. 2 is an illustration of steps of a method of storing user data files in fragmented, encrypted and obfuscated form within a user-centric data system pursuant to the present disclosure;

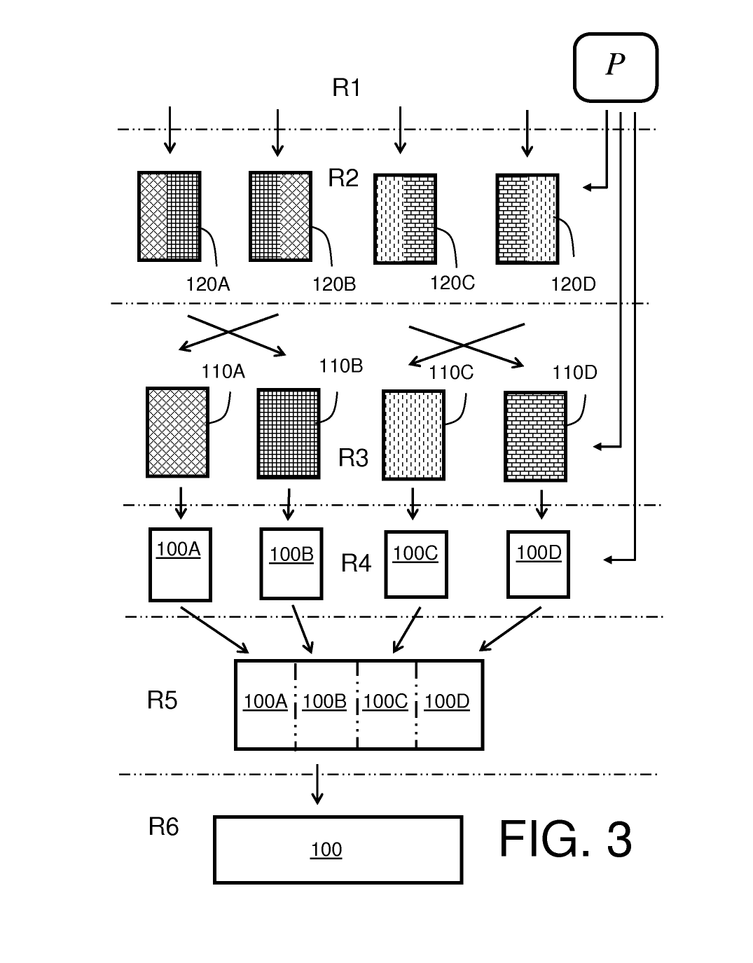

FIG. 3 is an illustration of steps of a method of retrieving user data files in de-fragmented, decrypted and de-obfuscated form within a user-centric data system pursuant to the present disclosure;

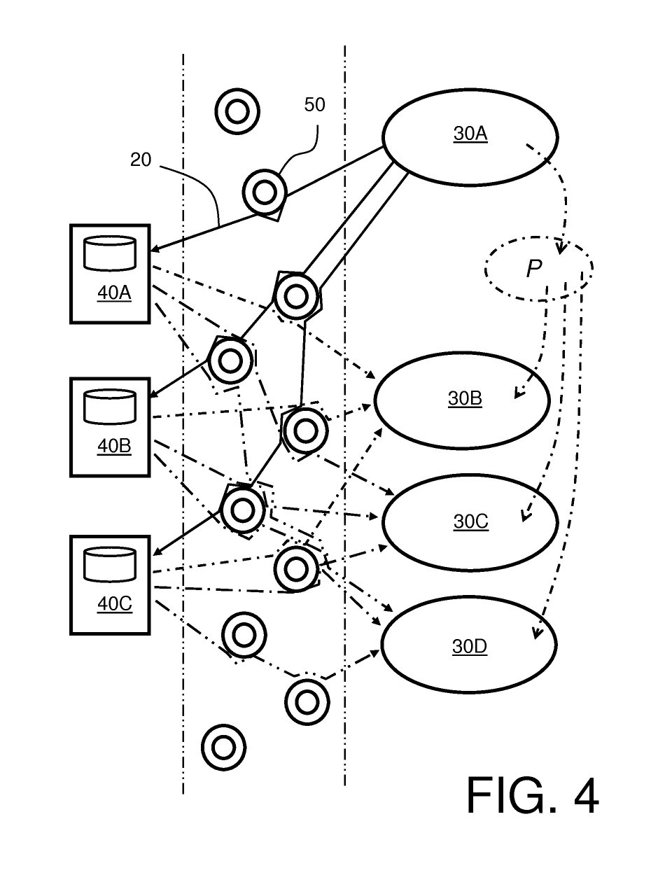

FIG. 4 is an illustration of a data system implemented in a user-centric manner for sharing data in an obfuscated encrypted manner between a plurality of user devices of the data system;

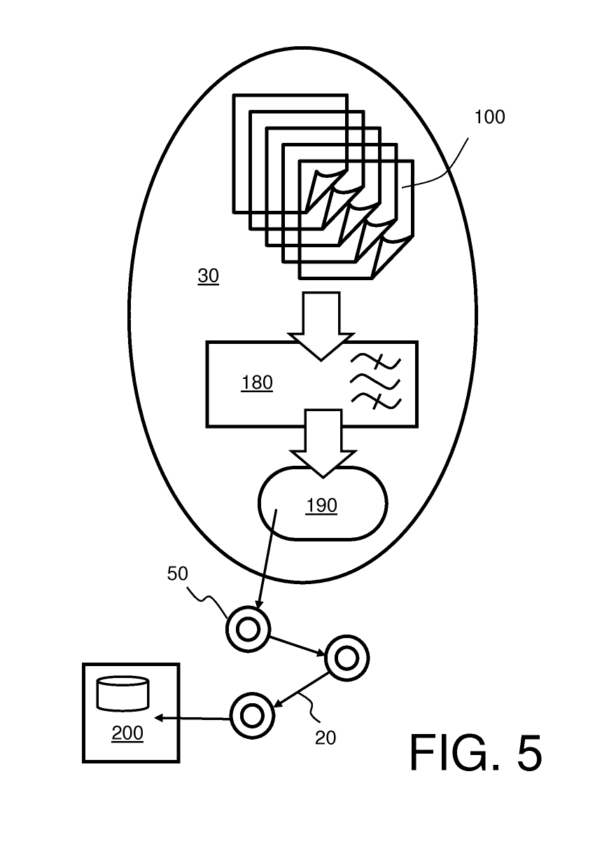

FIG. 5 is an illustration of generation of anonymous metadata files within the data system of FIG. 1 and their storage at one or more nodal elements for use by search engines;

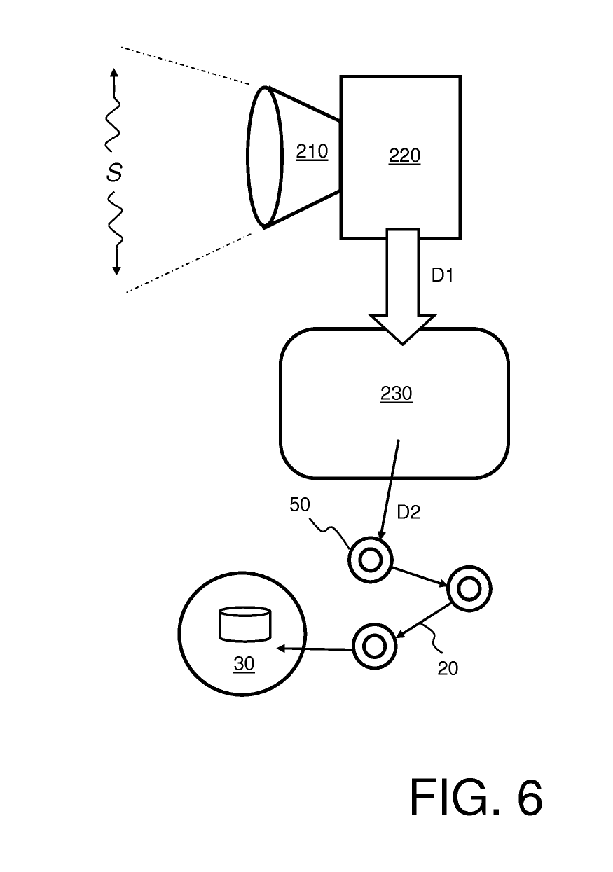

FIG. 6 is an illustration of use of the data system of FIG. 1 for remote sensing;

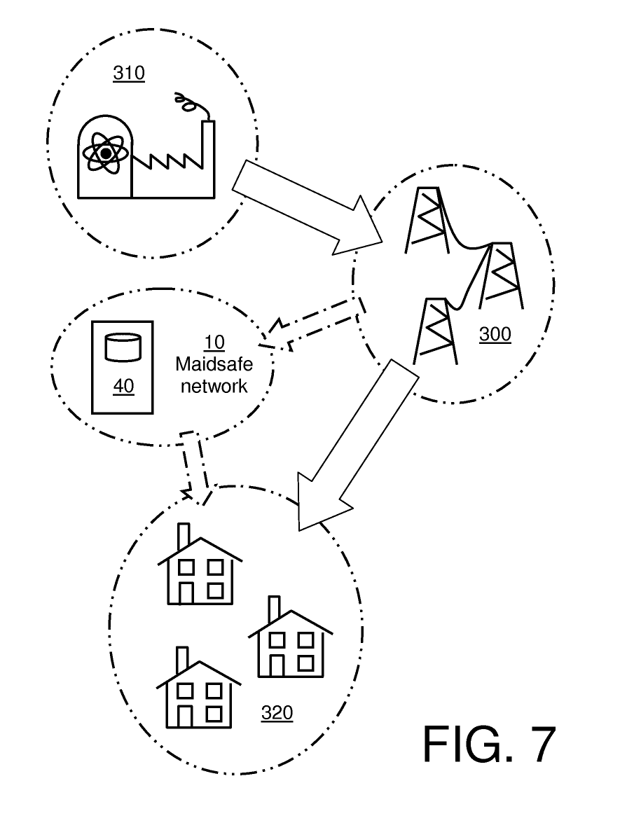

FIG. 7 is an illustration of use of the data system of FIG. 1 for remote control purposes;

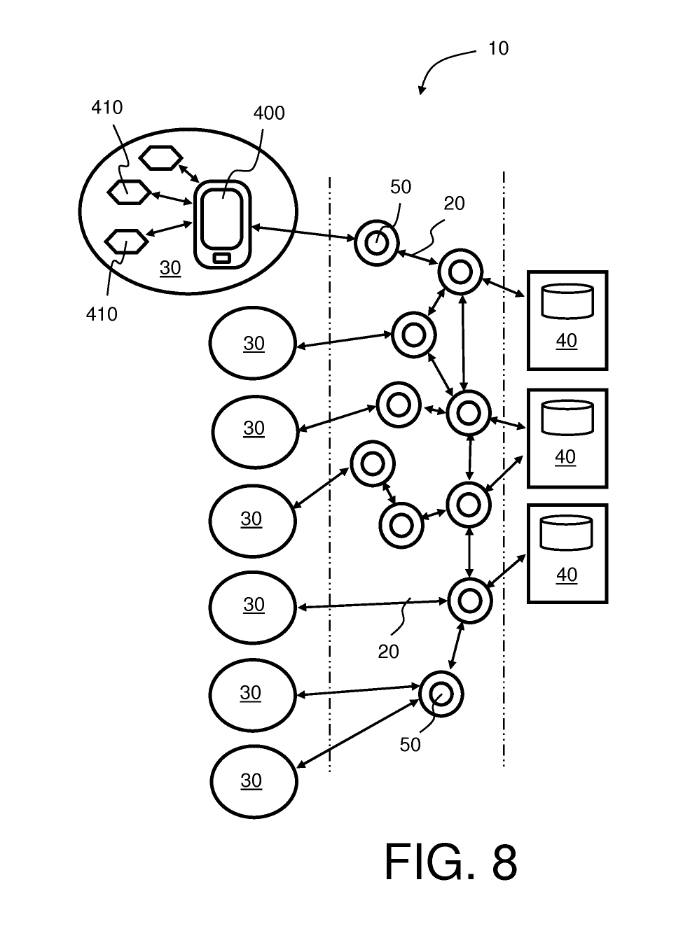

FIG. 8 is an illustration of a user device implemented as a relay device and one or more near-field satellite devices which are operable to communicate with the relay device, enabling a constellation of user-variable devices to be worn by an associated user; and

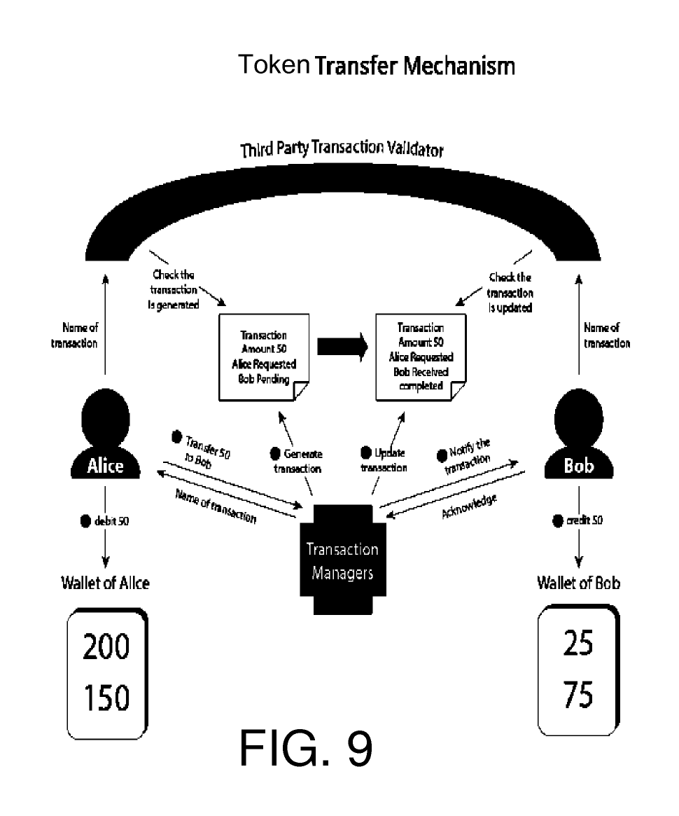

FIG. 9 is an illustration of the data system of FIG. 1 used for purposes of token distribution and management.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

In view of the present status of data management, there is a need for implementing a data communication system in a manner which is less susceptible to contemporary surveillance, and which is less likely to be abused by operators of servers of the system storing user data, for example, in a “cloud computing” environment. Moreover, there is a need for a data communication system in which users determine a degree of data mining rather than operators of servers of the data communication system. This need is not overcome by contemporary approaches to the Internet, wherein “cloud computing” is greatly encouraged by parties benefitting commercially from data mining.

Referring to FIG. 1, a data communication system 10, includes an arrangement of elements coupled via communication links 20. The elements include but are not limited to user devices 30, nodal elements 40 and routers 50. Communication links 20 may include but are not limited to wireless links, optical fibre links, wired links and similar. The user devices 30 may include but is not limited to personal computers, mobile telephones, smart phones, tablet computers and remote cameras.

In operation of the system 10, user data is stored in data memory of user devices 30, as “local data”, in data storage media of nodal elements 40 as “remote data” or both of these.

In overview, the present disclosure is concerned with data systems which are more user-centric. The data systems employ a configuration of elements such as that demonstrated in FIG. 1, in a manner employing novel storage and access of. In an example user-centric data system pursuant to the present disclosure, a given user has one or more of his/her user data files substantially intact only at a computing device of the given user, and/or at one or more computing devices of one or more other users respectively which the given user has allowed to receive the user data files. Elsewhere in the user-centric data system, for example at nodal elements 40, the user's data is stored in fragmented, encrypted and obfuscated form. A record of data fragmentation, encryption and obfuscation applied to each of the data fragments is recorded in an encrypted data map to which only the given user has access, or to one or more other parties to which the given user has granted permission. Due to the computational infeasibility, an unauthorized third party cannot reconstitute or regenerate the given user's data files from the fragmented, encrypted and obfuscated form to mine data, in contradistinction to known data systems in which users data is stored intact in external servers of a data network, as in contemporary “cloud computing”.

System 10 is configured to provide a secure access for everyone (SAFE) network, for example by way of its peer-to-peer (P2P) decentralized data and communications network. Moreover, the system 10 provides, in operation, a secure and anonymous network which is implemented via spare computing resources from its users.

Data fragmentation, encryption and obfuscation will next be described with reference to FIG. 2. In a step S1, the given user generates a data file denoted by 100. The data file 100 exists locally within a computing device of the given user, for example, in a personal computer (PC), a tablet computer, a smart phone, a smart wrist-worn device, etc. In an example embodiment of the disclosure, data file 100 exists only at a specific user software layer of a software operating system of the computing device of the given user. This measure prevents spyware from, unbeknown to the given user, executing at a different software layer of the user's computing device relative to the specific user software layer and gaining access to data file 100.

In a step S2, as shown in FIG. 2, data file 100 is partitioned to generate a plurality of fragments. While for example four fragments 100A, 1008, 100C, 100D are depicted in FIG. 2, other numbers of fragments are feasible. In one example, fragments 100A, 1008, 100C, 100D are of similar sizes. In one example, fragments 100A, 1008, 100C, 100D are of different sizes. In a step S3, data indicative of a manner in which the data file 100 is partitioned into fragments is recorded in a parameter file denoted by “P”. In an embodiment, partitioning of data file 100 is implemented using a function which is seeded, or “salted”, by one or more passwords provided by the given user.

In a step S4, the fragments produced from step S3 are subject to encryption to generate corresponding encrypted fragments. In an example, fragments 100A, 1008, 100C, 100D are encrypted to generate corresponding encrypted data files 110A, 1108, 110C, 110D, respectively. During encryption of fragments 100A, 1008, 100C, 100D into encrypted data files 110A, 1108, 110C, 110D, data indicative of the encryption applied is also included in the parameter file denoted by “P”. In an example, a mutually similar encryption algorithm is employed to encrypt the fragments 100A, 1008, 100C, 100D to generate the encrypted data files 110A, 1108, 110C, 110D. In an example, mutually dissimilar encryption algorithms are employed to encrypt fragments 100A, 1008, 100C, 100D to generate the encrypted data files 110A, 1108, 110C, 110D. In an example, selection of the encryption algorithm employed to encrypt the fragments 100A, 1008, 100C, 100D to generate the encrypted data files 110A, 1108, 110C, 110D is implemented using a function which is seeded, or “salted”, by one or more passwords provided by the given user. Although four encrypted data files are described, it will be appreciated that other numbers of encrypted data files are optionally employed.

In a step S5, encrypted data files 110A, 1108, 110C, 110D are subject to obfuscation. In an example, obfuscation is achieved by swapping one or more bytes of data between the encrypted data files 110A, 1108, 110C, 110D, to generate corresponding obfuscated data files 120A, 120B, 120C, 120D respectfully. In an example, obfuscation is achieved using a simple logic function native to a data processor of the given user's computing device. For example, the simple logic function may include an XOR function. Data indicative of a manner in which the obfuscation is implemented is also included in the parameter file denoted by “P”. Although four obfuscated data files are described, it will be appreciated that other numbers of encrypted data files are optionally employed.

Subsequently, the parameter file P and the obfuscated data files 120A, 120B, 120C, 120D are stored on a data storage medium of the given user's computing device. Storage may be, for example, on an encrypted hard disc drive or non-volatile solid state data memory of the given user's computing device. In an example, obfuscated data files 120A, 120B, 120C, 120D are stored on one or more of nodal elements 40. The one or more nodal elements 40 are operable to store obfuscated data files 120 in multiple copies on the one or more nodal elements and to employ a majority voting system to detect and repair any errors arising in the obfuscated data files 120A, 120B, 120C, 120D. In an example, the parameter file P is stored on a different nodal element 40 relative to one or more nodal elements 40 storing obfuscated data files 120A, 120B, 120C, 120D. In an embodiment, parameter file P is stored in encrypted form, and is accessible to the given user with a password known to that user.

Recovery of a data file from the one or more elements 40 of the system 10 is next described with reference to FIG. 3. In a first step R1, the given user loads or otherwise recovers the parameter file P, which is may be stored in an encrypted state either on the given user's computing device and/or at a nodal element 40 of the network 10. Access to the parameter file P, which may function as a data map, is achieved via use of at least one password known to the given user.

In a step R2, the parameter file P is decrypted and the locations of the obfuscated data files 120A, 120B, 120C, 120D are determined. Obfuscated data files 120A, 120B, 120C, 120D are recovered from their respective one or more nodal elements 40 and provided to the computing device of the given user. In a step R3, obfuscation processes used to generate the obfuscated data files 120A, 120B, 120C, 120D are determined from the parameter file P, and an inverse of these processes is then applied to the obfuscated data files 120A, 120B, 120C, 120D to regenerate corresponding encrypted data files 110A, 1108, 110C, 110D.

In a step R4, encryption processes that were used to generate the encrypted data files 110A, 1108, 110C, 110D are determined from the parameter file P, and inverses of such encryption processes are applied to the encrypted data files 110A, 1108, 110C, 110D to generate corresponding decrypted fragments 100A, 1008, 100C, 100D. In a step R5, a manner of fragmentation that was used to generate the fragments 100A, 1008, 100C, 100D is determined from the parameter file P, and an inverse of such fragmentation is then applied to the fragments 100A, 1008, 100C, 100D to regenerate the data file 100. Again, it will be appreciated that while four fragments have been shown in FIG. 3 for simplicity of illustration, other numbers of fragments can be employed.

It will be appreciated from the forgoing that data file 100 only exists in a complete intact form within the computing device of the given user, and exists in a fragmented, encrypted and obfuscated form within the system 10, spatially remote from the given user's computing device. Methods associated with FIG. 2 and FIG. 3 enable, for example a secure and confidential data storage arrangement or data “repository” to be provided to the given user via the system 10 in a manner which substantially renders third-party eavesdropping impossible.

System 10, when implemented in a user-centric manner pursuant to the present disclosure, is not limited to merely functioning as a box into which users may drop their data files, as described in the foregoing, but is also operable to share data files between one or more other users. When data file sharing is performed, shared data files are only created, recovered or reconstituted at computing devices of users who have mutually agreed beforehand to share the data files. Nevertheless, system 10 is also capable of broadcasting data files to all users of the system, namely publically.

As illustrated in FIG. 4, a user of a user device 30A may share his/her data file 100 by generating the parameter file P which is provided to other user devices 30A, 30B, 30C. The data file 100 is fragmented, encrypted and obfuscated, as aforementioned, and obfuscated encrypted fragments of the data file 100 are stored in a plurality of nodal elements 40A, 40B, 40C. Nodal elements 40A, 40B, 40C are operable to supply the obfuscated encrypted fragments to other user devices 30B, 30C, 30D, are operable to regenerate the obfuscated, encrypted fragments into replicas of data file 100 locally at these computing devices. The parameter file P is also provided to other user devices 30B, 30C, 30D to enable their computing devices to regenerate the replicas of data file 100. Optionally, the nodal elements 40A, 40B, 40C, for example data storage devices, are implemented in a proxy manner, namely the user devices 30B, 30C, 30D are only provided access to data storage devices, for example data servers, which mirror content of the nodal elements 40A, 40B, 40C to which the user device 30A has access.

The system 10 as implemented pursuant to FIG. 4 allows for secure and confidential file sharing, for example document sharing, between user devices 30. Such a manner of operation may be implemented for document databases for large organisations whose offices and staff are spatially distributed. Moreover, such manners of operation are useful for activities which require a very high degree of confidentiality, for example legal firm management. Flows of obfuscated encrypted fragments along paths as depicted in FIG. 4 may be bi-directional. Bi-directional operation may be implemented in real-time, allowing Voice Over Internet Protocol-type (VoIP)-type telephony and video conferencing to be achieved, without a risk of eavesdropping by unauthorized third parties. In an example, encrypted end-to-end messaging, both for e-mail and Short Messaging Service (SMS) is employed for such (VoIP)-type communication. In an example, during bi-directional real-time operation, system 10 is operable to switch between a any of a plurality of different parameter files P, such that if any third party managing to break into the bi-directional communication, system 10 is able to reconfigure itself frequently to thwart eavesdropping. This switching of parameters may operate in a manner akin to “frequency-hopping” in conventional wireless communication systems.

In an embodiment, system 10 is operable to store, recover and share its data files by employing obfuscated encrypted data fragments, and is also operable to generate other types of related user-defined metadata files which are made available to system 10 for data mining purposes. Maintenance of system 10, nodal elements 40 and data links 20, requires financial resources, which, in a case of the contemporary Internet, is paid for by advertising and data mining activities. In the conventional Internet, users have little control, if any, regarding an extent of data mining which is performed on user's data. System 10 enables the user-defined metadata to be used for user-targeted advertising and data mining under the control of the users of the system 10. For example, some users of the system will be eager to share their data as widely as possible, whereas other users will prefer to maintain a maximum degree of data security and confidentiality.

Rather than providing control to operators of servers to delete, analyze and disseminate user data stored in the servers system 10 provides control to users of the user devices 30. However, system 10 is further provided with a management function, for example for controlling use of the nodal elements 40, data repair when multiple copies of user fragments are stored at the nodal elements 40 without any information about what the user fragments concern. In a majority-voting arrangement employed to detect data errors, if a given user's data fragment is stored in multiple copies, in an event that a first copy of the multiple copies deviates from two more mutually similar copies, the first copy is determined by system 10 to be in error. Such error is, may be corrected in system 10 by overwrite the first copy with either of the other copies. Other majority-voting arrangements such as parity-bit checking may be employed. If a given nodal element 40 consistently results in data error from, for example, a fault in one or more of its hard disc drives or a malware infection, the given node is recorded by the system 10 as a bad node, and data provided from user devices 30 is directed to other nodes recorded as being reliable. In one example, this recording is implemented gradually via a ranking mechanism.

System 10 may be configured to function in a peer-to-peer (P2P) manner, in which user devices send their data fragments as data into a communication network of the system 10 with an indication of a nodal element 40 in which the data is to be stored, and the network passes the data in a peer-to-peer manner, until the data reaches the specified nodal element 40 Nodal element 40 may be defined by a form of resource locator resembling a URL as in conventional HTTP. However, other types of communication protocol may be employed. Use of a peer-to-peer network configuration for the system 10 removes control from any manager of system 10 and in favour of the users of devices 30.

In data system 10, data files 100 are only present in complete form at the devices 30 and otherwise exist only in a fragmented, obfuscated and encrypted manner elsewhere in the data system 10, as aforementioned. In an embodiment, user devices 30 may include one or more data filters 180, as illustrated in FIG. 6. In an example, data filters 180 may be implemented as one or more executable software applications (“Apps”), which are operable to process complete users' intact data files 100 at their user devices 30 and generate corresponding metadata files 190 which are communicated from the user devices 30 to one or more nodal elements 200 or 40 of the system 10. Data filters 180 are implemented to selectively transmit metadata files 190 therethrough, to one or more nodal elements 200. In an example, information content being selectively transmitted through the one or more data filters are determined in accordance with parameters such as keywords and thresholds for selected by the user, so that users are capable of controlling a degree of confidentiality provided by data system 10. As such, users of system 10 have control regarding a degree of data mining and analysis applied to their data files

Metadata collected at the one or more nodal elements 200 or 40 of data system 100 may be used for targeted advertising purposes for sending advertisements to one or more of user devices 30. Advertisers engaging such advertising may pay a fee to support operating costs of the one or more nodal elements 40 storing obfuscated, encrypted fragments on behalf of user devices 30. A portion of an advertising fee may be paid to one or more users of system 10. Moreover, metadata may be used for search engines which support operation of the data system 10.

Metadata is automatically generated in the user devices 30 by performing a statistical analysis of words occurring in one or more texts in the data files 100, and/or by performing image matching of images occurring in the data files 100 with reference images stored locally in the user devices 30 or downloaded from a remote database.

When the statistical analysis of words is performed, frequently occurring words are filtered out, and only less frequently occurring words are included in the corresponding metadata; and such a manner, significant nouns, adjectives, adverbs and verbs are isolated for inclusion in the metadata. Thresholds applied in combination with the statistical analysis are user-controllable, thereby enabling users to control a degree of confidentiality of their data files 100 relative to corresponding metadata.

The system 10 is operable to detect any unexpected data flows associated with activities of Spyware, Adware and other malware, and to alert users of devices 30 accordingly. Data flows occurring from the at least one user device in operation are monitored and detected a discrepancies between size and/or temporal characteristics of the monitored data flows and expected size and/or temporal characteristics of data flows from the device are used to uncover malware.

System 10 is suitable for use in remote sensing applications where confidentiality and reliability of captured data are critical and where that data is provided from a multiplicity of camera sources. User devices 30 may take the form of one or more cameras. Referring to FIG. 7, an image of a scene S is projected via one or more optical components 210 onto an optical sensor 220 such as a CCD or CMOS pixel sensor array, which generates corresponding data D1 depicting scene S. Data D1 is provided to processing hardware 230 which is operable to fragment the data D1, and then apply encryption and obfuscation processes to the fragmented data to generate corresponding obfuscated, encrypted data fragments D2 which are communicated through routers 50 and links 20 to one or more associated user device 30. Obfuscated, encrypted fragments D2 may additionally or alternatively be recorded at one or more nodal elements 40 for future reference. For example images encoded in data D1 may provide legal evidence of a robbery usable in legal trials. As with user devices 30, processing hardware 230 is operable to generate a corresponding parameter file “P” as part of the fragmenting, obfuscating and encrypting processes. This enables users to remotely monitor their homes, and other property in a confidential manner incompatible with third-party eavesdropping.

System 10 is suitable for providing an alternative to contemporary fiat currency systems and is also capable of being used for handling derivative contracts, namely “derivatives”. When records of derivatives contracts are stored via use of obfuscated encrypted fragments of data in one or more nodal elements 40 of system 10, there is thereby provided a more reliable foundation for performing derivatives transactions. By way of nodal elements 40 having their data duplicated in a plurality of data storage sites and majority-voting error correction being employed for data stored at one or more nodal elements 40, a very high degree of data storage reliability in system 10 may be achieved.

System 10 may be managed in order to reduce response times for user devices 30. Data flow management within the system 10 is implemented in a distributed and/or a centralized manner.

In a first manner of operation, when routers 50 and links 20 are implemented pursuant to http IP protocol, for example, data flows via routers 50 are reported to a control facility of system 10 that then sends control information to the one or more user devices 30, for enabling them to send their obfuscated encrypted fragments via alternative routers 50 which are less loaded with data flow. Alternatively, in a second manner of operation, data flows via the routers 50 are reported directly to one or more user devices 30 sending data to them for enabling the one or more user devices 30 to select alternative routes to send their obfuscated encrypted fragments. Optionally, a combination of the first and second manners of operation is employed within the data system 10. Similar consideration also pertain to the one or more nodal elements 40, when they are sending obfuscated encrypted fragments back to the one or more user devices 30. To avoid abuse by third parties desirous to eavesdrop upon the data system 10, routes of data flows of obfuscated encrypted fragments through the routers 50 may be monitored and unexpected diversion of obfuscated encrypted fragments may be flagged as a potential eavesdropping event, and one or more alternative data communication routes through the routers 50 and data links 20 may be selected to thwart such eavesdropping.

The data system 10 is well adapted for providing video-on-demand by way of use of obfuscated encrypted fragments, representative of video content, present at the one or more nodal elements 40 which are supplied on demand, for example in exchange for consideration, for example one or more payments, from the one or more user devices 30. Such supply of video content may be achieved by supplying an appropriate parameter file P to the one or more user devices 30. On receipt of the parameter file P, the one or more user devices 30 are operable to retrieve appropriate obfuscated, encrypted fragments and reassemble them, in a manner previously elucidated with reference to FIG. 3. In an example, one or more of the obfuscated encrypted fragments are made specific to a given user device 30 that has requested the video content, such that the video content, when reassembled at the given user device 30 is watermarked with one or more visual references which are specific to the given user 30. In an example, the one or more visual references are momentary or otherwise transient, and thus not noticed by viewers, or are overlaid as a subtle watermark, for an extended period of playing. In an event that the given user makes a copy of the video content, for as presented on a screen of the given user device 30, or extracted at a software level from screen video driver software of the given user device 30, the watermarking information is also copied and allows the given user, for example a content creator, to be identified from the copies. In an example, additional watermarking information is added at the given user device 30 to that provided in obfuscated encrypted fragments provided from the one or more nodal elements 40 of the data system 10.

Use of the parameter file P provided to the one or more user devices 30 in association with given video content provided via supply of obfuscated encrypted fragments enables the obfuscated encrypted fragments to be sent to nodal elements 40 deployed in a spatially distributed manner, near to the one or more user devices 30; and the associated parameter file P for accessing the block-buster film to be provided to the one or more user devices 30, wherein the obfuscated encrypted fragments are accessed from nodal elements 40 which are connection-wise substantially nearest to each of the one or more user devices 30.

In this arrangement, data traffic within data system 10, via communication links 20 and routes 50, is reduced, provided that user devices 30 are provided substantially with obfuscated encrypted fragments from nodal elements 40 which are spatially closest thereto. In this respect, the parameter files P provided to user devices 30 are made user-device-specific, depending upon connection positions of user devices 30 within data system 10. Use of the parameter file P to enable access to video enables access to the video to be controlled.

Data system 10 facilitates overlay of second data content onto other first data content, for example, when a temporal sequence of video images from a second source are to be overlaid onto a temporal sequence video images from a first source to generate a composite video content. For example, data system 10 may be operable to provide a music performance environment for user devices 30, and their associated one or more users, wherein a user of a given user device 30 receives a first parameter file P1 to enable obfuscated, encrypted fragments relating to a music backing track to be downloaded to the given user device 30 and reassembled thereat to provide the back track at the given user device 30. In an example, the user of the given device 30 makes a payment for receiving first parameter file P1. In an example, parameter file P1 includes identifying information of the given user device 30 which is uniquely present as a form of watermark in the music backing track. In an example, the identifying information in parameter file P1 is included in subsequent parameter files, for example in a parameter file P2 which will be described below.

The backing track is played at the given use device 30 concurrently while the given user device 30 is used to record an overlay solo track to overlay temporally onto the backing track to provide a composite music track at the given user device 30. Thereafter, the composite music track is fragmented, encrypted and obfuscated, for example in a manner as depicted in FIG. 2, and stored in nodal elements 40, and a record is made at one or more of the nodal elements 40 of a parameter file P2 pertaining to the composite music track. In an example, additional tracks may be overlaid onto the composite music track to generate further, more complex, music tracks. In an example, parameter file P2 includes information indicative of an identity of the backing music track, information indicative of downloading the backing track to the given user device 30, and information indicative of the given user device 30 having overlaid a solo track onto the backing track to generate the composite music track. Thus, by recording parameter files P1, P2 and any later parameter files P_{N} for further music content with more overlaid music tracks, at a nodal element 40 of data system 10 responsible for royalty payments and copyright enforcement, such a manner of operation of the data system 10 provides for a music environment wherein musicians are able to add their music tracks onto other music tracks, and then publish their composite musical creations. In an example, publication of musical creations, may return royalty payments and/or advertising of their musical talent. Data system 10 is capable of being used in a similar manner for video content, pursuant to an embodiment of the present disclosure.

On account of its use of obfuscate encrypted fragments of data file, as well as its data duplication and error correction processes implemented at the one or more nodal elements 40, the data system 10 is capable of providing The confidential and reliable data communication provided by data system 10 enables use of system 10 for smart grid purposes, as illustrated in FIG. 8. Power generated by one or more generators 310 is coupled via an electrical power grid 300 to one or more consumers 320. In operation, a need arises within the electrical power grid 300 to match power supplied from generators 310 with demand from consumers 320, for example domestic and/or commercial premises. Both supply of power from generators 310, and power consumed by consumers 320 can be potentially highly variable. It will be appreciated that balancing power generation with power demand in respect of a complex electrical power distribution network is not a trivial task. Changing weather conditions influence an amount of power which is generated by renewable energy sources. Uranium or MOX solid-fuel nuclear reactors must operate at full power, otherwise build-up of Xenon and Krypton gas on fuel rods at lower fuel rod operating temperatures results in unstable absorption of neutron flux and unstable operation.

Smart electrical meters are often Internet-enabled so that they may send and receive information n via the Internet. For example, such smart meters are operable to measure cumulative power consumption within a house, and then send such cumulative power consumption information to an electric supply company for periodic invoicing purposes. Moreover, such power meter also enable instructions to be sent to houses, for performing load shedding when the electrical power grid 300 is heavily overloaded, namely during period of peak power demand. However, such a conventional configuration is potentially susceptible to cyber-attack; for example, an entire national power grid could be destabilized causing a general blackout or brownout by an Internet virus which affects the smart meters. Embodiments of the present disclosure address sending grid power balancing commands to consumers 320 via data system 10 using obfuscated encrypted fragments of data. Data system 10 offers greater security of information regarding power consumption at consumers 320. When load-shedding commands from a controlling authority responsible for keeping grid 300 in power balance are communicated via data system 10 to consumers 320 greater security is available. When employed to send power balancing and load-shedding commands, data system 10 may be operable to aggregate consumption information obtained from consumers 320 in a confidential, reliable manner, to generate aggregated power information. Aggregated power information may be later used to improve power balance within grid 300.

In a similar manner to electric power grid 300 of FIG. 8, data system 10 may find use as a control for other types of spatially distributed apparatus.

In a traffic control system with traffic lights configured to wirelessly receive control signals from a traffic control centre, traffic flow may be managed and commends may be sent from the traffic control center to the traffic lights via data system 10. Traffic light control commands communicated to the traffic lights in an obfuscated, encrypted, fragmented manner avoid third party tampering. New traffic lights may be easily added, and traffic flows can be readily controlled from the aforesaid traffic control centre in emergencies.

In a railway control system with spatially distributed railway signs, level crossing barriers and railway track points wirelessly coupled to a railway control centre, data may be communicated between the railway control centre and the spatially distributed components in an obfuscated, encrypted, fragmented manner to protect data communication confidentiality and data communication robustness.

Data system 10 may be employed when a highly robust, confidential and large-data-capacity storage of data is required. Data system 10 may be employed for use with database booking systems used for travel bookings, car hire and stock control; confidential voting systems; digital libraries; and remote schooling for educational establishments.

Network-based computer games, which are played interactively in real-time by a plurality of players require sharing data content between a plurality of players. For example, background video information and playing character symbols and outlines are shared so that each player experiences a consistent game reality. This shared data may be provided to the plurality of players in an obfuscated encrypted manner, for example as depicted in FIG. 3. When implemented in a network-based computer game, a hosting arrangement at one or more of nodal elements 40 provides one or more parameter files to the plurality of players when a given game is activated and played. When the players receive one or more parameter files they are able to upload background video information, games software and data fields for recording scoring and are then able to start game play. Data is exchanged between players during game play so that character symbols and outlines move in a mutually coordinated manner This exchanged data is either communicated directly between one or more user devices 30, and/or is communicated in an obfuscated, encrypted manner referred to in FIG. 2 and FIG. 3. Scores resulting from playing games between the one or more players may be stored in an obfuscated, encrypted, fragmented manner in one or more of nodal elements 40, such that a best player performance recorded there optionally invokes payments for outstanding game-playing performance by one or more of the plurality of players.

In other embodiments, system 10 may be used by hospital databases, police databases, relief aid organisations, and/or search engines.

User devices 30 may be implemented, at least in part, as user-wearable devices, for example as arm bands, wrist-worn devices or even incorporated into user clothing.

In an example illustrated by FIG. 9, a given user device 30 is implemented as a wireless communication device 400, such as a smart phone, which is operable to communicate with one or more user-wearable devices 410, for example via wireless communication employing BlueTooth™ or Zigbee™ protocol. When system 10 is implemented in such a manner, users may employ user-wearable devices 410 as multiple sensors distributed over their bodies, allowing, for example, remote sensing and/or recording of health status while maintaining user confidentiality. Moreover, user device 30 may be implemented such user-wearable devices 410 execute primary data chunking to generate primary data chunks and data obfuscation between the primary data chunks to generate primary, obfuscated data chunks. Wireless communication device 400 may receive the primary obfuscated data chunks, and executes secondary data chunking to the primary, obfuscated data chunks to generate secondary data chunks and data obfuscation between the secondary data chunks to generate secondary, obfuscated data chunks for transmission from wireless communication device 400. Multiple stages of data chunking and obfuscation involve use of a plurality of data maps for use when reconstituting the secondary obfuscated data chunks to regenerate corresponding original data of the one or more user-wearable devices 410. Thus, spatially local eavesdropping of data flows between wireless communication device 400 and the one or more user-wearable devices 410 is prevented. When one or more of the one or more user-wearable devices 410 are configured for cryptocurrency payment, for example, as a wrist band which the given user offers to a payment terminal when making cryptocurrency payment preventing eavesdropping can prevent theft.

In an embodiment, a user-wearable device 410 in the form of a wrist band includes a camera for capturing a short video clip of a given cryptocurrency transaction and the short video clip is recorded remotely, confidentially and securely within system 10 for subsequent recall as proof the transaction was made. User device 30 may be implemented as a wireless communication device 400 as described here, or as a fixed-installation with its associated one or more user-wearable devices 410. As examples, a user-wearable configuration of system 10 may be used by police, emergency services, rescue services, medical services where confidential information collection is necessary to protect user confidentiality and privacy.

In another related aspect of the present disclosure, the system 10 may be implemented to provide a decentralized network token exchange system.

Tokens of the exchange system provide their holder, with perceived economic or social benefit in return for acting out defined and desired actions.

User are able to contribute to operation of the system 10 by way of, for example, tokens, as aforementioned. Tokens may be cryptographic tokens of system 10, wherein the token is employed to encourage users and contributors to the system. Distribution of tokens is handled entirely by the network on a per use basis. Each token has its own unique identity and is required to access services on the network of the system 10.

In the system 10, tokens, may be obtained through one or more of farming, assisting with maintaining underlying code of system 10, creating software applications for system 10 and purchasing using a fiat currency such as US dollar, or European Euro.

During farming, users of the system 10 provide computing resources, such as bandwidth, data storage space and CPU processing capacity to system 10. For example, when a given user creates his/her credentials, he/she sets up a token wallet within system 10, with a network client./ The wallet is cryptographically linked to the user's account hosted by system 10. In system 10, the token farming rate is a result of a network rate, wherein tokens are issued to a successful node, for example user, as data is retrieved from it (GETS), as opposed to when data is stored there (PUTS).

System 10 may increase token farming rewards, as increased computing resources are required for operating system 10. and similarly reduce token farming rewards as capacity of the network becomes abundant. Thus, the farming rate is dynamically variable in response to operating conditions of system 10. Data is substantially evenly distributed in the network of the system 10, and thus farmers of tokens seeking to increase their earnings may consider running several average nodal elements 40, rather than one high-specification node.

As part of token distribution, system 10 employs a proof of resource process, operable to validate, in a continuous manner, who and what is providing resource to system 10. Validation is implemented in a mathematically verifiable manner. In other words, validation is performed during attempts to store data chunks onto and retrieve data chunks from nodal elements 40, respectively. Ability for a given node being validated to implement such storage and retrieval operations is dependent upon a combination of CPU speed, bandwidth availability, unused data storage capacity and online-time when coupled to communicate with system 10. In one embodiment, system 10 employs a “zero knowledge proof mechanism”, wherein the content of data to be checked need not be known, but the data must be known to be actually held and not subject to data corruption and damage. Nodes that are either unreliable or that are known to be removing previously provided resources, are de-ranked by the network, thereby removing their ability to perform farming of tokens.

Core developers, namely users who are able to develop an underlying network for the system 10, are able to earn tokens for their efforts. As core developers create and release new software applications, they code their token wallet address into their software applications, to receive rewards for their efforts. Issuing of tokens may be dependent upon, for example, how successful the software applications are for users of system 10. In an example, the success of a software application may be determined as a function of number of user accessing the software applications and/or number of downloads of the software applications.

System 10 employs decentralized, peer-to-peer (P2P) exchanges when in operation so as to provide users with an opportunity to buy tokens. Moreover, the exchanges serve as platforms for enabling a given buyer and a given seller to trade mutually directly, using a multi-signature approach. For example, three or more private keys are associated with an address, and a majority of parties holding such private keys must sign to make a given associated transaction valid. Alternatively, or additionally, system 10 is configured to support centralized exchanges for trading tokens. Such exchanges may support conversion of tokens to other types of crypto-currencies. IToken value may be determined by a market created within an environment of the system 10 for such tokens. Such a market is subject to economic forces of supply and demand.

In an embodiment, system 10 employs a transaction manager. For token transactions within system 10, only past and current owners of a given token are known thus enabling a high degree of anonymity comparable to real, physical fiat currency. A transaction manager may be an entity or role carried out by vaults of system 10 used to store data pertaining to a given farmer's computer. A vault comprises a series of processes or roles that vary between managing storage of data, managing other vaults and managing processing and completion of token transactions.

In an embodiment of system 10, the token network reaches decisions based on a consensus of a close group of nodal elements 40, and the transaction manager is a trusted group of nodal elements closest to any given transaction identity. Close groups, may be chosen or selected by system 10 based upon the closeness of node ID's in respect of a given token. Closeness may refer, for example, to an XOR distance, or to a geographical distance.

Referring next to FIG. 10, there is provided an illustration of a token transaction mechanism employed within system 10. One or more transaction managers mediate between users “Alice” and “Bob” regarding a payment of 50 tokens. Four steps are performed by the mechanism. In a first step, S1, a request is sent from Alice to the one or more transaction managers that a 50 token payment to Bob is to be implemented. In a second step S2, the one or more transaction managers generate conditions for a transaction to occur. In a third step S3, transaction information is updated. In a fourth step S4, Bob is notified of the transaction of 50 tokens as having been implemented.

Within system 10, transfer of data may be atomic, using a cryptographic signature to demonstrate that a last person, for example the user Alice, who owned a given token has signed the given token over to a current owner, for example to the user Bob. When the current owner desires to spend the given token, the current owner asks a network, for example their close group of 32 nodes, to accept a signed message transferring ownership to a subsequent user, namely to a new owner of the given token. Knowledge of ownership of the given token is kept in a plurality close groups, and each group is operable to agree upon and reach consensus on the transfer of ownership of the given token before the transaction of change of ownership of the given token is processed. For example, 28 of 32 nodes must be in mutual agreement. In this way, double spending of a given token may be avoided.

In system 10, generation of tokens, namely minting of tokens, is achieved by registering a special type of transaction with the one or more transaction managers. The special type of transaction facilitates transfer of the ownership of a given token to any user that acknowledges the transaction. For example, when user Alice wants to mint a token, she sends a request to transfer the token to anyone. Once the one or more transaction managers have confirmed by consensus that Alice is the current owner of the given token, they will then generate the transaction, for example, in a manner as depicted in FIG. 10. When Alice receives a transaction name from the network, she is able to store it on a data storage device such as an external data storage device such as a USB drive, together with a special validation signature which has been used as a salt when requesting transfer of the given token. This salt which may be, for example, one or more salt values generated from a salt value generating function, prevents the one or more transaction managers themselves trying to acknowledge the transaction for purposes of attempting to steal the given token.

When user Bob receives the minted token, he reads the transaction name and the validation signature from the storage device and then sends an acknowledgement to system 10. Once the one or more transaction managers receive the acknowledgement, the transaction will be updated, thereby completing the transfer of the ownership of the given token from user Alice to user Bob. In such a manner of operation, Alice does not need to keep her secret key safe, because the transaction is pre-generated. As such, theft of a given private key does not necessarily indicate loss of an associated token.

Tokens of the disclosed implementation of system 10 are network-led, backed by data, and generated dependent upon retrieval of data from nodal elements 40, and token transactions can be implemented rapidly.

Tokens can be employed within system 10 for paying for various products and services. For example, tokens can be used to pay for films on a cost-per-frame basis, with a given user only paying for what the given user watches. Similar payment arrangements can be employed for music content and blogging. Token payments may be linked to contemporary copyright laws, so that content creators are compensated for their creative effort.

Token payments are, for example, made by users employing their user-wearable devices compatible with system 10, as described in the foregoing.

Modifications to embodiments of the disclosure described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1-35. (canceled)

36. A non-transitory computer-readable medium for communicating data within a data system, wherein the data system includes at least one user device and a configuration of nodal elements operable to communicate with the at least one user device, wherein the computer-readable medium includes instructions stored thereon, that when executed on a processor cause one or more computers to perform the steps of: communicating data within the data system in a secure format which includes data chunks which have been encrypted and obfuscated and are defined by one or more data maps.

37-38. (canceled)

39. The non-transitory computer-readable medium as set forth in claim 36, wherein the instructions stored thereon, when executed on a processor, cause one or more computers to perform the steps of: receiving power consumption data communicated in the secure format from electrical power consumption meters associated with the one or more user devices.

40-42. (canceled)

43. The non-transitory computer-readable medium as set forth in claim 36, wherein the instructions stored thereon, when executed on a processor, cause one or more computers to perform the steps of:
monitoring data flows occurring from the at least one user device in operation; and
uncovering malware by detecting a discrepancy between size and/or temporal characteristics of the monitored data flows and expected size and/or temporal characteristics of data flows from the device.

44-47. (canceled)

48. The non-transitory computer-readable medium as set forth in claim 36, wherein communicating data within the system in a secure format further comprises communicating the data within the system in the secure format between the configuration of nodal elements and the at least one user device which includes at least one intermediate device spatially locally coupled to at least one user-wearable device.

49. The non-transitory computer-readable medium as set forth in claim 37, wherein the instructions stored thereon, when executed on a processor cause the one user-wearable device to perform the step of: transacting cryptocurrency payments on behalf of a user associated with the one user-wearable device.

50. The non-transitory computer-readable medium as set forth in claim 48, wherein the instructions stored thereon, when executed on a processor, cause one or more computers to perform the steps of:
communicating, via the at least one intermediate device, sensor data corresponding to a sensor included with the one user-wearable device and configured to sense in a spatial region of the one user-wearable device; and
storing the sensor data at one or more nodal elements of the data system.

51. The non-transitory computer-readable medium as set forth in claim 48, wherein the instructions stored thereon, when executed on a processor, cause one or more computers to perform the steps of:
constructing a primary format, which includes data chunks which have been encrypted and obfuscated and are defined by one or more data maps;
communicating data in the primary format from the at least one user-wearable device to the at least one intermediate device;
constructing a secondary format, which includes data chunks which have been encrypted and obfuscated and are defined by one or more data maps; and
communicating further the data in the primary format from the at least one intermediate device to one or more nodal elements of the data system.

52. A data system for providing data communication and data storage, wherein the data system includes at least one user device and a configuration of nodal elements which is operable to communicate with the at least one user device, wherein the data system is operable to communicate data therein in a format which includes data chunks which have been encrypted and obfuscated and are defined by one or more data maps.

53. The data system as set forth in claim 52, wherein the data system is operable to receive power consumption data communicated from electrical power consumption meters associated with the one or more user devices, wherein the power consumption data is communicated in the format.

54. The data system as set forth in claim 52, wherein the at least one user device includes a protection arrangement operable to:
monitor data flows occurring from the at least one user device in operation; and
uncover malware by detecting a discrepancy between size of data flow and/or temporal characteristics of the monitored flows and expected size of data flow and/or temporal characteristics of data flows from the device.

55. The data system as set forth in claim 52, wherein the at least one user device includes at least one intermediate device which is spatially locally coupled to at least one user-wearable device.

56. The data system as set forth in claim 55, wherein the one user-wearable device is operable to enable cryptocurrency payments to be made by an associated user of the at least one user device.

57. The data system as set forth in claim 56, wherein the at least one user-wearable device includes at least one sensor for sensing in a spatial region of the at least one user-wearable device, and for communicating corresponding sensor data from the at least one user-wearable device via the at least one intermediate device for storage at one or more nodal elements of the data system.

58. The data system as set forth in claim 57, wherein the data system is operable to employ, for communicating data from the at least one user-wearable device to the at least one intermediate device, a primary format including data chunks which have been encrypted and obfuscated and are defined by one or more data maps, and to employ, for communicating further the data in the primary format from the at least one intermediate device to one or more nodal elements of the data system, a secondary format including data chunks which have been encrypted and obfuscated and are defined by one or more data maps.

59. A method of communicating data within a data system for providing data communication, wherein the data system includes at least one user device and a configuration of nodal elements which is operable to communicate with the at least one user device, wherein the method includes operating the data system to communicate data therein in a format which includes data chunks which have been encrypted and obfuscated and are defined by one or more data maps.

60. The method as set forth in claim 59, wherein the method includes arranging for the system to employ a primary format, which includes data chunks which have been encrypted and obfuscated and are defined by one of more data maps, for communicating data from the at least one user-wearable device to the at least one intermediate device, and to employ a secondary format, which includes data chunks which have been encrypted and obfuscated and are defined by one or more data maps, for communicating further the data in the primary format from the at least one intermediate device to one or more nodal elements of the data system.

61. The method as set forth in claim 59, wherein the data system is operable to receive power consumption data communicated from electrical power consumption meters associated with the one or more user devices, wherein the power consumption data is communicated in the format.

62. The method as set forth in claim 59, further comprising:
monitoring data flows occurring from the at least one device in operation; and uncovering malware by detecting a discrepancy between the size of data flow and/or temporal characteristics of the monitored data flows with the expected size of data flow and/or temporal characteristics from the device.

63. The method as set forth in claim 59, further comprising arranging for the at least one user device to include at least one intermediate device which is spatially locally coupled to at least one user-wearable device.

64. The method as set forth in claim 63, wherein the one user-wearable device is operable to enable cryptocurrency payments to be made by an associated user of the at least one user device.

65. The method as set forth in claim 63, wherein the method includes arranging for the at least one user-wearable device to include at least one sensor for sensing in a spatial region of the at least one user-wearable device, and for communicating corresponding sensor data from the at least one user-wearable device via the at least one intermediate device for storage at one or more nodal elements of the data system.
